(19) United States
(12) Patent Application Publication
(10) Pub. No.: US 2025/0029367 A1
(43) Pub. Date: Jan. 23, 2025

(54) COMPONENT IDENTIFICATION METHOD AND APPARATUS, ELECTRONIC DEVICE, AND STORAGE MEDIUM

(71) Applicants: BEIJING WODONG TIANJUN INFORMATION TECHNOLOGY CO., LTD., Beijing (CN); BEIJING JINGDONG CENTURY TRADING CO., LTD., Beijing (CN)

(72) Inventor: Shu XIA, Beijing (CN)

(21) Appl. No.: 18/713,146

(22) PCT Filed: Nov. 25, 2022
(86) PCT No.: PCT/CN2022/134361

§ 371 Date: May 23, 2024

(30) Foreign Application Priority Data
Nov. 26, 2021 (CN) 202111422206.X

(51) Int. Cl. G06V 10/764; G06F 3/04815; G06T 5/50; G06T 7/13; G06V 20/70

(52) U.S. Cl. CPC G06V 10/764; G06F 3/04815; G06T 5/50; G06T 7/13; G06V 20/70; G06T 2207/20081; G06T 2207/20132; G06T 2207/20221

(57) ABSTRACT

The present disclosure provides a component identification method which includes: inputting a first image into a set identification model to obtain at least one UI block in the first image outputted by the set identification model, wherein the first image is determined on the basis of a first visual mockup, the set identification model is used for identifying the at least one UI block in an inputted image, and each UI block at least comprises an image region obtained by UI component rendering; determining, among the nodes of a document object model DOM corresponding to the first visual mockup, a first node corresponding to each UI block in the at least one UI block; inputting an image corresponding to each first node into a set classification model to obtain a UI component type corresponding to the first node outputted by the set classification model.

### CROSS-REFERENCE TO RELATED APPLICATIONS

This invention is filed based on a Chinese patent application with the application No. 202111422206 and with the application date Nov. 26, 2021, and claims the priority of the Chinese patent application, the entire contents of which are hereby incorporated by reference into this invention.

### TECHNICAL FIELD

The present disclosure relates to the field of computer technology, and relates to a component identification method and apparatus, an electronic device, and a storage medium.

### BACKGROUND

In a front-end business development process, in order to generate corresponding user interface (UI) codes in a visual mockup by component codes, it is necessary to manually identify and annotate UI component types corresponding to nodes in a corresponding document object model (DOM). The above approach has a problem of low efficiency.

### SUMMARY

In view of this, the embodiments of the present disclosure provide a component identification method and apparatus, an electronic device, and a storage medium to at least solve a problem that the related technology has low efficiency in component identification.

The technical solution of the embodiments of the present disclosure is implemented as follows:
the embodiments of the present disclosure provide a component identification method, comprising:
inputting a first image into a set identification model to obtain at least one UI block in the first image outputted by the set identification model, wherein the first image is determined on the basis of a first visual mockup, the set identification model is used for identifying the at least one UI block in an inputted image, and each UI block at least comprises an image region obtained by UI component rendering:
determining, among the nodes of a document object model DOM corresponding to the first visual mockup, a first node corresponding to each UI block in the at least one UI block;
inputting an image corresponding to each first node into a set classification model to obtain a UI component type corresponding to the first node outputted by the set classification model, wherein the set classification model is used for determining a UI component type corresponding to an inputted image.

In the above solution, determining, among the nodes of a document object model (DOM) corresponding to the first visual mockup, a first node corresponding to each UI block in the at least one UI block includes:
traversing the nodes of a document object model DOM corresponding to the first visual mockup;
when a region overlap rate is greater than a first set threshold, determining a node corresponding to the region overlap rate as a first node corresponding to the first UI block, wherein
the region overlap rate represents the overlap rate between a second image and the first UI block, and the second image is obtained by cropping the first visual mockup according to the node information of the node.

In the above solution, prior to inputting a first image into a set identification model, the method further comprises:
determining, through edge detection, at least two first rectangular regions in the first visual mockup;
cropping the first visual mockup based on at least one first rectangular region to obtain a corresponding first image.

In the above solution, cropping the first visual mockup based on at least one first rectangular region includes:
merging the first rectangular regions which are adjacent in a set direction to obtain a second rectangular region, wherein the length of the second rectangular region in the set direction is smaller than a second set threshold;
cropping the first visual mockup based on the second rectangular region.

In the above solution, inputting an image corresponding to each first node into a set classification model includes:
inputting a second image which is obtained by cropping the first visual mockup according to the node information of the first node into the set classification model;
and/or,
inputting a third image which is obtained by cropping the first visual mockup according to the UI block corresponding to the first node into the set classification model.

In the above solution, prior to inputting a first image into a set identification model, the method further comprises:
training the set identification model and the set classification model based on a second visual mockup with at least one first annotation, wherein
the first annotation includes first position information of an image region that can be obtained by UI component rendering and a corresponding first label, the first position information is used for describing the position of the image region in the second visual mockup, and the first label is used for describing the type of the UI components.

In the above solution, training the set identification model and the set classification model based on a second visual mockup with at least one first annotation includes:
cropping the second visual mockup based on each first annotation to obtain corresponding fourth images, wherein the fourth images are accordingly provided with first labels;
replacing the first labels of the second visual mockup with second labels to obtain fifth images, wherein the second labels represents that the corresponding image regions are UI blocks;
training the set classification model based on the fourth images;
training the set identification model based on the fifth images.

In the above solution, prior to training the set classification model based on the fourth images, the method further comprises:
when the number of the fourth images corresponding to at least one first label is smaller than a third set threshold, generating a page image containing corresponding UI component types, and obtaining a corresponding fourth image based on the generated page image.

In the above solution, generating a page image containing corresponding UI component types includes:
rendering the component codes of the corresponding UI component types on a set interface to obtain a page image containing corresponding UI component types;
and/or,
obtaining a third visual mockup with a visual mockup generation code tool to obtain a page image containing corresponding UI component type.

The embodiments of the present disclosure also provide a component identification apparatus, comprising:
a first processing module configured to input a first image into a set identification model to obtain at least one UI block in the first image outputted by the set identification model, wherein the first image is determined on the basis of a first visual mockup, the set identification model is configured to identify the at least one UI block in an inputted image, and each UI block at least comprises an image region obtained by UI component rendering;
a second processing module configured to determine, among the nodes of a document object model DOM corresponding to the first visual mockup, a first node corresponding to each UI block in the at least one UI block;
a third processing module configured to input an image corresponding to each first node into a set classification model to obtain a UI component type corresponding to the first node outputted by the set classification model, wherein the set classification model is configured to determine a UI component type corresponding to an inputted image.

The embodiments of the present disclosure also provide an electronic device, comprising: a processor and a memory for storing a computer program that can run on the processor,
wherein the processor is used to execute the steps of the above component identification method when running the computer program.

The embodiments of the present disclosure also provide a storage medium storing thereon a computer program which, when executed by the processor, perform the steps of the above component identification method.

The embodiments of the present disclosure provide a component identification method and apparatus, an electronic device and a storage medium, wherein the solution comprises: inputting a first image into a set identification model to obtain at least one UI block in the first image outputted by the set identification model, wherein the first image is determined on the basis of a first visual mockup, the set identification model is used for identifying the at least one UI block in an inputted image, and each UI block at least comprises an image region obtained by UI component rendering: determining, among the nodes of a document object model DOM corresponding to the first visual mockup, a first node corresponding to each UI block in the at least one UI block: inputting an image corresponding to each first node into a set classification model to obtain a UI component type corresponding to the first node outputted by the set classification model, wherein the set classification model is used for determining a UI component type corresponding to an inputted image. In the above solution, image regions that can be obtained by rendering UI components in the first visual mockup are determined by the set identification model, the first nodes of these image regions are determined among the nodes of the document object model DOM corresponding to the first mockup, and UI component types corresponding to the first nodes are obtained by the set classification model. In such way, it is not necessary to manually annotate the UI component types of the nodes in the DOM corresponding to the visual mockup, which improves the efficiency of component identification.

### DESCRIPTION OF THE DRAWINGS

FIG. 1 is a schematic flowchart where a component identification method provided by the embodiments of the present disclosure is implemented;

FIG. 2 is a schematic diagram where UI blocks in an image provided by the embodiments of the present disclosure are identified;

FIG. 3 is a schematic flowchart where determining of a node provided by the embodiments of the present disclosure is implemented;

FIG. 4 is a schematic diagram where the UI block identification results provided by the embodiments of the present disclosure are shown;

FIG. 5 is a schematic flowchart where page segmentation provided by the embodiments of the present disclosure is implemented:

FIG. 6 is a schematic flowchart where component identification provided by the application embodiments of the present disclosure is implemented;

FIG. 7 is a schematic diagram where a page of the component identification provided by the application embodiments of the present disclosure is shown;

FIG. 8 is a flowchart where model training provided by the application embodiments of the present disclosure is implemented;

FIG. 9 is a schematic diagram where the structure of a component identification apparatus provided by the embodiments of the present disclosure is shown;

FIG. 10 is a schematic diagram where the structure of an electronic device provided by the embodiments of the present disclosure is shown.

### DESCRIPTION OF THE EMBODIMENTS

With the emergence of low-code and no-code platforms, a conversion from a visual mockup to application front-end codes can be realized with little or no coding. A process of generating UI codes from a visual mockup comprises inputting structured visual mockup data to obtain UI codes through the steps of layer information parsing, layout, component replacement, semantization, code generation and so on. Component replacement is a key step of generating UI codes from a visual mockup, including: developing common visual modules into components: determining, in the process of generating UI codes from a visual mockup, parts in the visual mockup that are consistent with the set visual modules; and replacing with codes of the corresponding components. A prerequisite for component replacement is to specify the parts in the visual mockup that can be replaced with components.

At present, in a front-end business development process, in order to generate corresponding UI codes in a visual mockup by component codes, it is necessary to manually identify and annotate UI component types corresponding to the nodes in a corresponding DOM. The above approach has a problem of low efficiency.

For this reason, in various embodiments of the present disclosure, the solution comprises: inputting a first image into a set identification model to obtain at least one UI block in the first image outputted by the set identification model, wherein the first image is determined on the basis of a first visual mockup, the set identification model is used for identifying the at least one UI block in an inputted image, and each UI block at least comprises an image region that can be obtained by UI component rendering: determining, among the nodes of a document object model DOM corresponding to the first visual mockup, a first node corresponding to each UI block in the at least one UI block: inputting an image corresponding to each first node into a set classification model to obtain a UI component type corresponding to the first node outputted by the set classification model, wherein the set classification model is used for determining a UI component type corresponding to the inputted image. In the above solution, image regions that can be obtained by UI component rendering in the first visual mockup and the first nodes of these image regions in the DOM corresponding to the first visual mockup are determined by a set identification model, and UI component types corresponding to the first nodes are obtained by a set classification model. In such way, it is not necessary to manually annotate the UI component types of the nodes in the DOM corresponding to the visual mockup, which improves the efficiency of component identification.

To make the purposes, technical solutions and advantages of the present disclosure clearer, the present disclosure will be further illustrated in details below with reference to the drawings and embodiments. It should be understood that the specific embodiments described herein are only used for interpretations of the present disclosure and are not used to limit the present disclosure.

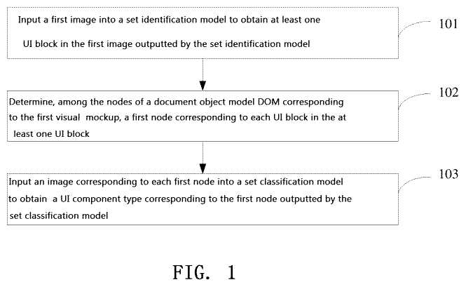

FIG. 1 is a schematic flowchart of the implementation of a component identification method provided by the embodiments of the present disclosure. The embodiments of the present disclosure provide a component identification method which is applied to an electronic device, wherein the electronic device includes, but is not limited to, a server and a terminal. As shown in FIG. 1, the component identification method comprises:

Step 101: Inputting a first image into a set identification model to obtain at least one UI block in the first image outputted by the set identification model,
wherein the first image is determined on the basis of a first visual mockup, the set identification model is used for identifying the at least one UI block in an inputted image, and each UI block at least comprises an image region obtained by UI component rendering.

The component identification apparatus inputs a first image into a set identification model, the set identification model identifies at least one UI block in the inputted first image, and each UI block at least comprises an image region that can be obtained by UI component rendering, wherein the set identification model is obtained by training a visual mockup annotated with UI blocks. The first image is determined on the basis of a first visual mockup, and it may be parts or all of the images of the first visual mockup. Each UI block is an image region and can be regarded as an image.

Step 102: Determining, among the nodes of a DOM corresponding to the first visual mockup, a first node corresponding to each UI block in the at least one UI block.

The component identification apparatus determines, based on each UI block in the at least one UI block determined by the set identification model and among the nodes corresponding to the first visual mockup, a first node corresponding to each UI block, wherein when a node and a certain UI block satisfy a set condition, the node is determined as the first node of the UI block.

Herein, the nodes of a DOM are nodes of structured data (i.e., Schema data) obtained by parsing a visual mockup. Schema data is a tree structure composed of all elements in a visual mockup, and it can be stored in a JSON (JavaScript Object Notation) format, each node including node information such as width, height, position and so on of a corresponding image.

Herein, images of the first visual mockup can be obtained according to the node information of a root node in the DOM corresponding to the visual mockup. The node information of the root node includes a uniform resource locator (URL) address of a complete page preview.

Step 103: Inputting an image corresponding to each first node into a set classification model to obtain a UI component type corresponding to the first node outputted by the set classification model,
wherein the set classification model is used for determining a UI component type corresponding to the inputted image.

Herein, the component identification apparatus inputs an image corresponding to each first node into a set classification model, the set classification model classifies the UI component types of the inputted images to determine the UI component types corresponding to the images which correspond to the first nodes, thereby obtaining UI component types corresponding to the first nodes, wherein the set classification model is obtained by training images annotated with UI component types.

The determined classification result can be mounted in a JSON file.

In the solution provided by the embodiments of the present disclosure, first nodes corresponding to image regions that can be obtained by UI component rendering in the first visual mockup are determined, and UI component types corresponding to the first nodes are obtained by the set classification model. In this way, it is not necessary to manually annotate the UI component types of the nodes in the DOM corresponding to the visual mockup, which improves the efficiency of component identification.

Meanwhile, after determining the UI component types corresponding to the first nodes, the component identification apparatus generates UI codes based on the codes of the UI components of the corresponding types when converting the visual mockup into UI codes, which simplifies the programming work from a visual mockup to UI codes. The use of the codes of corresponding components can realize automated component replacement, which lowers the threshold for using UI code development.

Moreover, the component identification apparatus determines by a set identification model image regions that can be obtained by UI component rendering in the first visual mockup, determines corresponding first nodes, and inputs the images of these first nodes into a set classification model. In this way, the set classification model does not need to process the images of all nodes of the first visual mockup, which reduces the calculation amount of the model and saves the computing resources required for component identification.

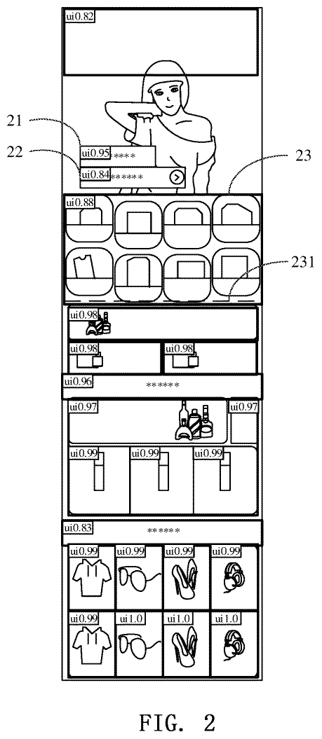

In addition, in the embodiments of the present disclosure, when a UI block is identified by the set identification model, the region of the identified UI block is not required to be exactly the same as an image region obtained by UI component rendering. In this way, requirements on the accuracy of the set classification model are loosened, and the robustness of the set identification model is improved. As shown in FIG. 2, the first image includes multiple UI blocks (21-23), wherein the UI block 23 is not exactly the same as the image region 231 obtained by UI component rendering, which, however, does has on influence on the set classification model in determining UI component types corresponding to the nodes.

In one embodiment, inputting an image corresponding to each first node into a set classification model includes:
inputting a second image which is obtained by cropping the first visual mockup according to the node information of the first node into the set classification model;
and/or,
inputting a third image which is obtained by cropping the first visual mockup according to the UI block corresponding to the first node into the set classification model.

Herein, the image corresponding to each first node of the set classification model as inputted by the component identification apparatus may be a second image obtained by cropping the first visual mockup according to the node information of the first node, or may be a third image obtained by cropping the first visual mockup according to the UI block corresponding to the first node, or may also be a second image corresponding to the first node and a third node. Since the edges of an identified UI block may not be accurate, the accuracy of the classification result can be improved when UI component type classification is performed for the second image cropped according to the node information.

Herein, when a node and a certain UI block satisfy a set condition, the node is determined as a first node of the UI block. In one embodiment, the set condition is that a region overlap rate between an image corresponding to the node and the UI block is greater than a set threshold.

Determining, among the nodes of a document object model DOM corresponding to the first visual mockup, a first node corresponding to each UI block in the at least one UI block includes:
traversing the nodes of a document object model DOM corresponding to the first visual mockup;
when a region overlap rate is greater than a first set threshold, determining a corresponding node as a first node corresponding to the first UI block, wherein
the region overlap rate represents a overlap rate between a second image and the first UI block, and the second image is obtained by cropping the first visual mockup according to the node information of the node.

When determining for each UI block a corresponding first node among the nodes of a DOM corresponding to the first visual mockup, the component identification apparatus traverses the nodes in the DOM corresponding to the first visual mockup, calculates a region overlap rate between a second image corresponding to a node and the UI block, and when the region overlap is greater than a first set threshold, determines the corresponding node as the first node corresponding to the first UI block. After the first node corresponding to the first UI block is determined, traversal of the remaining nodes in the DOM corresponding to the first visual mockup can be stopped, and a first node corresponding to a next first UI block can be determined again. A region coverage rate represents an image overlap condition between the UI block and a second image corresponding to the node, and a higher region coverage rate indicates a higher overlap ratio of the two images.

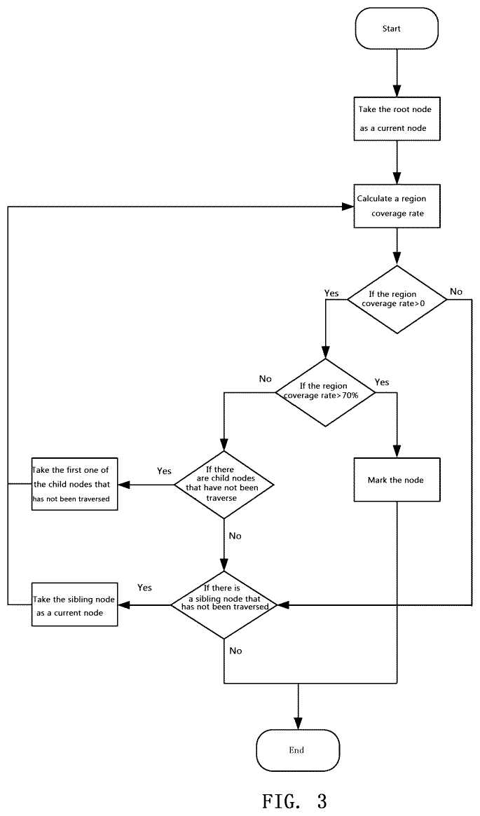

Herein, the traversal of the nodes in the DOM corresponding to the first visual mockup by the component identification apparatus may be a pre-order traversal, an in-order traversal or a post-order traversal. With reference to the schematic flowchart of determining a node as shown in FIG. 3, a pre-order traversal is taken as an example for illustrations, in which a set threshold is 0.7. For each first UI block, a preorder traversal is performed on the structured data (i.e., Schema data) of the visual mockup.

First, the component identification apparatus takes the root node as a current node and calculates a region coverage rate between a second image corresponding to the current node and the first UI block.

If the region coverage rate is not greater than 0, it indicates that the two do not intersect, and the node and its child nodes cannot correspond to the first UI block, and a determination is made as to whether this node has a sibling node that has not been traversed. If there is a sibling node that has not been traversed, the sibling node is taken as a current node and a region coverage rate is calculated.

If the region coverage rate is greater than 0 but smaller than or equal to 0.7, a determination is made as to whether this node has child nodes that have not been traversed. If there are child nodes that have not been traversed, a first one of the child nodes that have not been traversed is taken as a current node and a region coverage rate is calculated; if there are no child nodes that have not been traversed, a determination is made as to whether this node has a sibling node that has not been traversed; if there is a sibling node that has not been traversed, the sibling node is taken as a current node and a region coverage rate is calculated.

If the region coverage rate is greater than 0.7, the node is considered to correspond to the first UI block, and this node is determined and marked as the first node corresponding to the first UI block. A {‘smart_ui’: ‘ui} field is added to the JSON information of the node to mark the node.

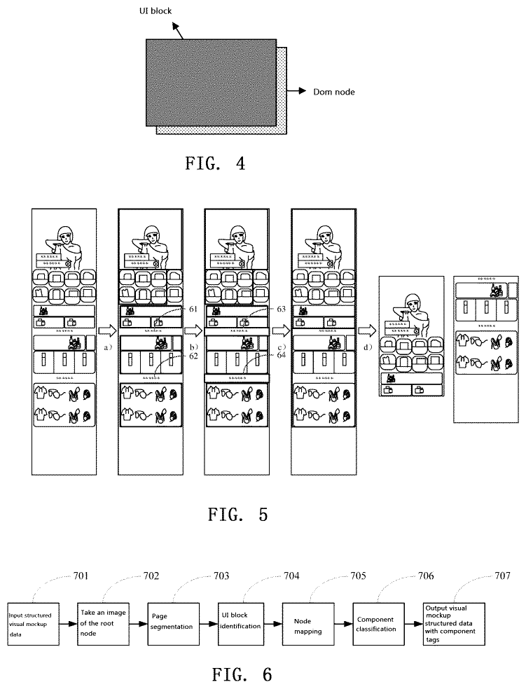

As stated previously, when a UI block is identified by the set identification model, a region of the identified UI block is not required to be exactly the same as an image region obtained by UI component rendering. That is to say, in the schematic diagram of the UI block identification result as shown in FIG. 4, the edges of the identified UI block are not completely accurate. In this embodiment, by determining a first node corresponding to a UI block, an image corresponding to the first node can be further obtained, which improves the accuracy of the classification result of the set classification model.

In one embodiment, prior to inputting a first image into a set identification model, the method further comprises:
determining, through edge detection, at least two first rectangular regions in the first visual mockup;
cropping the first visual mockup based on at least one first rectangular region to obtain a corresponding first image.

The component identification apparatus determines image edge features through an image algorithm such as edge detection or the like, identifies at least two first rectangular regions of the first visual mockup based on edge detection, divides the at least two first rectangular areas, and obtains a corresponding first image each time the first visual mockup is cropped based on at least one first rectangular region.

The component identification apparatus identifies block elements (i.e., first rectangular regions) in the image based on edge detection, wherein an element detection module which performs an open source algorithm UI2CODE on the visual mockup generation codes may be used, which will not destroy images of the nodes with complete outlines.

In this way, without destroying images of the nodes with complete outlines, the first visual mockup is segmented into at least two images, and the aspect ratios of the segmented images are within an optimal identification effect range of the set identification model, such that the accuracy of identifying UI blocks of a long visual mockup is increased and the identification effect of images by the set identification model is improved.

In one embodiment, when cropping the first visual mockup based on at least one first rectangular region, the method comprises:
merging the first rectangular regions which are adjacent in a set direction to obtain a second rectangular region, wherein the length of the second rectangular region in the set direction is smaller than a second set threshold;
cropping the first visual mockup based on the second rectangular region,
wherein the set direction may be a vertical direction, i.e., a y-axis direction.

The component identification apparatus merges at least two first rectangular regions, of which a sum of the lengths in the set direction is smaller than the second set threshold, to obtain a second rectangular region, and crops the first visual mockup based on the second rectangular region.

Herein, the component identification apparatus can sequentially judge whether a sum of the lengths of two adjacent first rectangular regions in the set direction is smaller than the second set threshold, merges the two first rectangular regions if the sum of the lengths is smaller than the second set threshold, continues to determine a sum of the lengths of the merged rectangular region and a next adjacent first rectangular region in the set direction until a sum of the lengths of the two rectangular regions in the set direction is greater than or equal to the second set threshold, and crops the first visual mockup based on the merged rectangular regions.

Illustrations will be made with reference to the schematic flowchart of the implementation of page segmentation as shown in FIG. 5, and segmentation of a visual mockup includes the following steps:
a) Identifying block elements (i.e. first rectangular regions) in an image based on edge detection, wherein an element detection module which performs an open source algorithm UI2CODE on visual mockup generation codes can be used, which sets the parameter threshold of the element detection module to be an appropriate size and obtains multiple first rectangular regions after detection. Since the element detection module performs segmentation based on image edge information, it will not destroy images of the nodes with complete outlines.
b) Ranking the identified first rectangular regions according to the y-axis coordinate, i.e., ranking according to distances to the top of the visual mockup.

Herein, in order to avoid the loss of undetected region information, rectangular regions can be inserted between the first rectangular regions for filling. For example, elements 61 and 62 in FIG. 5 are not identified and detected, and rectangular regions 63 and 64 are inserted to ensure that the corresponding information will not be lost.
c) Grouping the first rectangular regions. The first rectangular regions are merged from top to bottom, wherein when a merged height is <400, merging proceeds downward: if a merged height is >600, the current second rectangular regions which are merged become a new group; then, next first rectangular regions are taken to be grouped, wherein the height is a set length in the vertical direction.
d) Cropping the first visual draft based on the second rectangular regions to obtain first images of appropriate heights.

Since a set identification model is trained by a visual mockup annotated with UI blocks, in consideration of a training cost and other factors, the number of training samples cannot be unlimited. For some images, such as images whose aspect ratios exceed the aspect ratio of the training samples, the identification effect by a set identification model is not good. In this embodiment, without destroying image regions that can be obtained by UI component rendering, the first visual mockup is segmented into at least two images, and the aspect ratios of the segmented images are within the optimal identification effect range of the set identification model, which thereby increases the accuracy of identifying UI blocks of a long visual mockup and improves the identification effect of the set identification model on images.

Each time at the processing of a new task scenario, it is necessary to train a model for the task scenario. Specific to a component identification scenario, before using a set identification model and a set classification model, it is necessary to train the models. In one embodiment, prior to inputting a first image into a set identification model, the method further comprises:
training the set identification model and the set classification model based on a second visual mockup with at least one first annotation, wherein,
the first annotation includes first position information of an image region that can be obtained by UI component rendering and a corresponding first label, the first position information is used for describing the position of the image region in the second visual mockup, and the first label is used for describing the type of the UI components.

The component identification apparatus determines the position of an image region that can be obtained by UI component rendering in the second visual mockup based on the first position information of each first annotation corresponding to the second visual mockup: determines the type of a UI component, through rendering of which this image region is obtained, based on the first label of each first annotation corresponding to the second visual mockup: determines a corresponding identification sample data set and a classification sample data set based on the images corresponding to the second visual mockup with at least one first annotation; and trains a corresponding model based on a corresponding data set, wherein the second visual mockup is a visual mockup sample, and it may be a real visual mockup or a visual draft generated as needed.

In one embodiment, training the set identification model and the set classification model based on a second visual mockup provided accordingly with at least one first annotation includes:
cropping the second visual mockup based on each first annotation to obtain corresponding fourth images, wherein the fourth images are accordingly provided with first labels;
replacing the first labels of the second visual mockup with second labels to obtain fifth images, wherein the second labels represent that the corresponding image regions are UI blocks;
training the set classification model based on the fourth images;
training the set identification model based on the fifth images.

The component identification apparatus crops the second visual mockup based on the first position information of each first annotation to obtain corresponding fourth images, wherein the fourth images are accordingly provided with first labels corresponding to the first annotations, the types of the UI components of the corresponding fourth images can be determined based on the first labels, and the set classification model is trained based on the fourth images.

The component identification apparatus replaces the first labels of the second visual mockup with the second labels to obtain fifth images, wherein the corresponding image regions can be determined as UI blocks based on the second labels of the fifth images, and the set identification model is trained based on the fifth images.

In this embodiment, the component identification apparatus can obtain two types of training samples by multiplexing the images of the second visual mockup, which are respectively used for training corresponding types of models. This reduces the cost of obtaining model training samples.

In one embodiment, prior to training the set classification model based on the fourth images, the method further comprises:
when the number of the fourth images corresponding to at least one first label is smaller than a third set threshold, the component identification apparatus generates a page image containing corresponding UI component types, and obtains a corresponding fourth image based on the generated page image;
when the number of fourth images containing a UI component type is smaller than a third set threshold, the component identification apparatus generates a page image corresponding to the UI component type, and then jitters the component node attributes, including a text change, an element position offset or the like, in the page with a tool such as Puppeteer, and takes a screenshot of the processed page to obtain a fourth image.

In one embodiment, generating a page image containing corresponding UI component types includes:
rendering the component codes of the corresponding UI component types on a set interface to obtain a page image containing corresponding UI component types;
and/or,
obtaining a third visual mockup with a visual mockup generation code tool to obtain a page image containing corresponding UI component types,
wherein the component identification apparatus can generate a web page image containing corresponding UI component types in at least one of the following manners: rendering the component codes of the corresponding UI component types in a page to obtain a corresponding web page image: using a visual mockup generation code tool to obtain a web page image restoring the visual mockup,
wherein the component identification apparatus can generate a web page image by calling component codes in a code library.

By generating training samples of a model, the component identification apparatus overcomes the problem of uneven distribution of samples of different component types in a data set. In this way, training the classification model based on a data set improves the accuracy of the classification model in classifying images.

The present disclosure will be further described in details below in conjunction with application examples.

FIG. 6 shows a schematic flowchart of the implementation of component identification provided by the application embodiments of the present disclosure.

The implementation process of component identification includes the following steps:

Step 701: Inputting structured visual mockup data Schema.

A common visual mockup is in a Sketch or psd format, and the input in the application embodiments is a structured data description obtained by parsing a visual mockup, i.e., schema data. Schema data is a tree structure composed of all elements in a visual mockup, stored in a JSON format, wherein each node includes node information such as width, height, position and so on.

Step 702: Taking an image of the root node as a visual mockup image.

The root node of the Schema data contains a URL address of a complete page preview, and the complete page preview is downloaded as the original visual mockup for subsequent processing.

Step 703: Page segmentation.

The component identification apparatus segments a long visual mockup into multiple images of appropriate heights using a page segmentation algorithm such as edge detection.

For a visual mockup with a large aspect ratio, it is impossible to achieve a better identification effect using a general target detection model, and therefore, it is necessary to segment the long visual mockup into images of appropriate heights. The process of page segmentation is shown in FIG. 5.

By page segmentation, a long visual mockup is segmented into images of appropriate heights, and segmentation is performed based on image edge features using an image algorithm such as edge detection, which will not destroy image regions that can be obtained by UI component rendering and solves a problem of the identification of a long visual mockup.

Target detection is one of the basic tasks in the field of computer vision, including two subtasks: object positioning and object classification. When an image is inputted, the category and position of a target object in the image can be found.

Step 704: UI block identification.

A UI block identification model (i.e., a set identification model) is used to identify at least one UI block in an image.

By UI block identification, regions (i.e., UI blocks) that may be components in an image are identified by a UI block identification model, wherein the UI block identification model is a target detection network model which is trained through a target detection data set with UI block labels based on a Mask-RCNN pre-training model of a deep learning target detection model.

Herein, data set is created with a Labelme tool, which annotates a collected visual mockup and annotates the positions and categories of the respective components in the visual mockup. The obtained annotation results are in a JSON format, in which the types and coordinates of the components are recorded and the annotation results are backed up. The types are uniformly replaced with “ui” through scripts. Then, a target detection data set is exported in a cocos format. Labelme is a data label tool that can be used for a common visual task, such as type labeling, detecting or segmenting, and it supports exporting in a VOC format, a COCO format and so on.

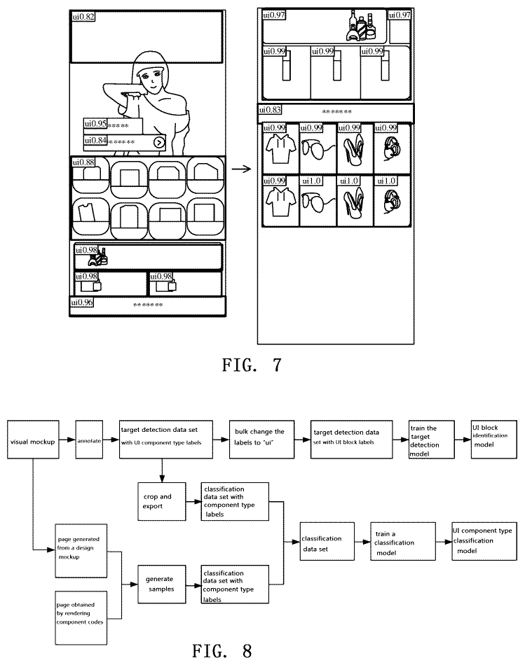

The component identification apparatus trains ad optimizes a model based on a target detection data set, and uses a trained UI block identification model for UI block identification. As for the images segmented in step 703, they are identified by the UI block identification model, and the coordinates and category “ui” of the UI blocks are obtained, as shown in FIG. 7 which is a schematic diagram of a page of component recognition page. The UI block identification model also outputs a confidence level corresponding to each identified UI block. For example, “ui 0.95” means that the confidence level of the image regions which are UI blocks is 0.95.

Step 705: Node mapping.

By calculating region coverage rates between the UI blocks of the image and the nodes of the DOM corresponding to the visual mockup, the component identification apparatus maps the identified blocks to the nodes in the visual mockup, and marks the nodes as UI blocks. Based on the region coverage rates, smaller nodes corresponding to the UI blocks in the visual mockup are determined, wherein the visual mockup data is the visual mockup inputted in step 701.

As shown in FIG. 4, the edges of the blocks identified by the UI block identification model are not accurate, and the blocks need to be mapped to the nodes in the visual mockup.

The implementation process of node mapping is shown in FIG. 3 (details are omitted). When a region coverage rate is greater than the first set threshold, the node is considered to correspond to the first UI block, and this node is determined and marked as a first node corresponding to the first UI block. A {‘smart_ui’: ‘ui} field is added to the JSON information of the node to mark it.

Step 706: Component classification.

The component identification apparatus crops UI block images from the original visual mockup according to the coordinates and width and height information of the nodes corresponding to the UI blocks, and delivers them to a UI type classification model (i.e., the set classification model) for classification to obtain the component types.

Image classification is one of the basic tasks in the field of computer vision. When an image is inputted, a classification result of the image will be outputted.

Step 707: Outputting visual mockup structured data with component tags.

Component tags are tags of the component types of the Dom nodes corresponding to the visual mockup.

In another application embodiment, UI component classification can be also performed for each node in the visual mockup.

The component identification apparatus obtains nodes that may be blocks through the above steps, and also needs to determine the UI component types corresponding to the nodes. The UI component types are classified by training a MobileNet classification model. Sources for the samples in a classification model data set include a real visual mockup and/or a generated visual mockup. For a real visual mockup, the visual mockup page is cropped using an annotated target detection data set according to the coordinates in the annotation information to obtain a classification data set, in which each sample has a corresponding UI component type label. For UI component types with too little data amount, the data set is expanded by generating samples.

After training a UI type classification model, the component identification apparatus crops images from the original visual mockup according to the node information of the marked UI block nodes such as coordinates, widths and heights, and sends them to the UI type classification model for inferences to obtain the types of UI components.

Herein, the determined classification results can be mounted in a JSON file.

In addition, in an application embodiment, after step 701, steps 702 and 703 can be skipped to directly execute step 704. Further, for visual mockups of different lengths, corresponding target detection data sets can be created and multiple UI block identification models can be trained, each model identifying input images of different lengths correspondingly. That is to say, after inputting structured visual mockup data in step 701, it is not necessary to segment the page. Instead, step 704 is executed directly to perform image identification using a UI block identification model that identifies corresponding lengths.

Here, with reference to the flowchart of the implementation of model training shown in FIG. 8, how to generate a data set for model training and how to train the model are further illustrated.

The component identification apparatus make annotations on a real visual mockup, the annotation information including component positions and UI component types, to obtain a target detection data set with UI component type labels (first labels). By modifying the UI component type labels to unified UI block labels (second labels) ‘ui’, a target detection data set with UI block labels is obtained. The target detection model is trained based on the target detection data set, and a UI block identification model (i.e., a set identification model) is obtained.

Based on the obtained target detection data set with UI component type labels, the component identification apparatus obtains a classification data set with UI component type labels by cropping and converting the target detection data set, judges whether the number of samples of UI component types with a smaller amount of data in the classification data set satisfies the set conditions, and trains a classification model based on the cropped and generated samples of the classification data set by generating samples of UI component types with a smaller amount of data, such that a UI component type classification model (i.e., the set classification model) is obtained.

Herein, the process of generating samples is as follows:

1) rendering a page with components.

Two manners can be employed, one is rendering component codes in the page, the other is using a visual mockup generation code tool to obtain a web page restoring the visual draft.

2) Using a Puppeteer tool to jitter the component node attributes in the page, including a text change, an element position offset and the like, and taking screenshots to obtain samples,

wherein Puppeteer is a node library, which controls Chrome or Chromium by the DevTools Protocol, can simulate operations such as manually opening web pages, clicking and the like based on a series of APIs which are provided, and can be used for screenshots, automated testing and so on.

In contrast, to identify the positions and types of UI components in an image by a deep learning network target detection model, it needs to prepare a large number of various types of samples for model training and annotate the large number of samples. Since the probability of occurrence of components in a real visual mockup is different, the number of samples of different types is very unbalanced, making it more difficult to prepare training samples. At the same time, a trained model can only identify a visual mockup with an aspect ratio in a certain range, and the identification effect of the model is not good.

In addition, in related technologies, classification can be also performed using a trained classification model by taking screenshots for each node of a visual mockup. Since it is necessary to traverse each node for classification, the calculation amount for the model is huge and the calculation cost is high.

In the present disclosure embodiment, the component identification apparatus greatly reduces the calculation amount by dividing the component identification into two stages: firstly, identifying UI blocks, i.e., regions which may be blocks, by target detection; then classifying the UI blocks to obtain corresponding UI component types. For example, there are 200 nodes in a visual mockup and there are 10 components that need to be identified. If each node in the visual draft is traversed to obtain a classification result, 200 node images need to be processed. By the solution of the present disclosure, it is only necessary to classify 10 images which are identified with block nodes after the target detection.

The training of a deep learning network requires a large number of samples, and the quality of the samples greatly determines an upper limit of the model effect. As a result of the differences in the use frequencies of different types of components, the distribution of the samples of different component types in a data set is uneven, and the identification and classification effects of component types with a small number of samples are very poor. Moreover, the cost of simulating and generating samples of a complete visual mockup image similar to a real visual mockup is relatively high, while the expansion of the generation of the samples of single UI components is more convenient and the required cost is lower. Since the images obtained by rendering some UI components have similar outline characteristics and high visual similarities, a UI block identification model trained based on the images corresponding to these UI components can also detect UI blocks of the UI components that appear less frequently, which reduces the number of samples required for the target detection data set. Then, the UI component types are specifically determined by the classification model. In the application embodiment of the present disclosure, images are processed by two models, and component identification can be completed only requiring fewer samples by multiplexing the training samples, which reduces the cost of obtaining training samples. At the same time, the problem of uneven distribution of samples of different component types in the data set is overcome by generating training samples. In this way, training the classification model based on a data set increases the accuracy of the classification model in classifying images and improves the identification effect of UI component types in a visual mockup.

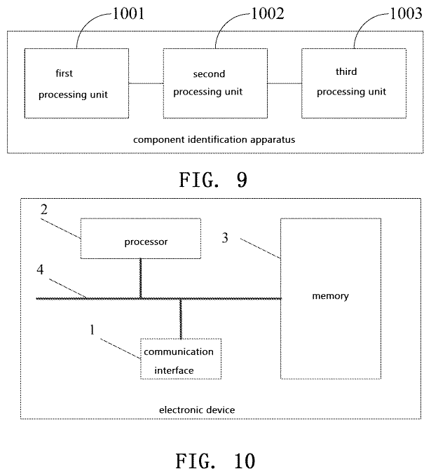

In order to implement the method in the embodiments of the present disclosure, the embodiments of the present disclosure also provide a component identification apparatus, as shown in FIG. 9, the apparatus comprising:
a first processing module 1001 configured to input a first image into a set identification model to obtain at least one UI block in the first image outputted by the set identification model, wherein the first image is determined on the basis of a first visual mockup, the set identification model is configured to identify at least one UI block in an inputted image, and each UI block at least comprises an image region that can be obtained by UI component rendering;
a second processing module 1002 configured to determine, among the nodes of a DOM corresponding to the first visual mockup, a first node corresponding to each UI block in the at least one UI block;
a third processing module 1003 configured to input an image corresponding to each first node into a set classification model to obtain a UI component type corresponding to the first node outputted by the set classification model, wherein the set classification model is configured to determine a UI component type corresponding to the inputted image.

Herein, in one embodiment, the second processing module 1002 is further configured to:
traverse the nodes of a document object model DOM corresponding to the first visual mockup;
when a region overlap rate is greater than a first set threshold, determine a node corresponding to the region overlap rate as a first node corresponding to the first UI block, wherein
the region overlap rate represents the overlap rate between a second image and the first UI block, and the second image is obtained by cropping the first visual mockup according to the node information of the node.

In one embodiment, the apparatus further comprises a cropping module configured to:
determine, through edge detection, at least two first rectangular regions in the first visual mockup;
crop the first visual mockup based on at least one first rectangular region to obtain a corresponding first image.

In one embodiment, the cropping module is further configured to:
merge the first rectangular regions which are adjacent in a set direction to obtain a second rectangular region, wherein the length of the second rectangular region in the set direction is smaller than a second set threshold;
crop the first visual mockup based on the second rectangular region.

In one embodiment, inputting an image corresponding to each first node into a set classification model includes:
inputting a second image which is obtained by cropping the first visual mockup according to the node information of the first node into the set classification model;
and/or,
inputting a third image which is obtained by cropping the first visual mockup according to the UI block corresponding to the first node into the set classification model.

In one embodiment, the apparatus further comprises a training module configured to:
training the set identification model and the set classification model based on a second visual mockup with at least one first annotation, wherein
the first annotation includes first position information of an image region that can be obtained by UI component rendering and a corresponding first label, the first position information is configured to describe the position of the image region in the second visual mockup, and the first label is configured to describe the type of the UI component.

In one embodiment, the training module is further configured to:
crop the second visual mockup based on each first annotation to obtain corresponding fourth images, wherein the fourth images are accordingly provided with first labels;
replace the first labels of the second visual mockup with second labels to obtain fifth images, wherein the second labels represents that the corresponding image regions are UI blocks;

train the set classification model based on the fourth images;
train the set identification model based on the fifth images.

In one embodiment, the apparatus further comprises a generating module configured to:
when the number of the fourth images corresponding to at least one first label is smaller than a third set threshold, generate a page image containing corresponding UI component types, and obtain a corresponding fourth image based on the generated page image.

In one embodiment, generating a page image containing corresponding UI component types includes:
rendering the component codes of the corresponding UI component types on a set interface to obtain a page image containing corresponding UI component types;
and/or,
obtaining a third visual mockup with a visual mockup generation code tool to obtain a page image containing corresponding UI component types.

In actual applications, the first processing module 1001, the second processing module 1002, the third processing module 1003, the cropping module, the training module and the generating module can be implemented based on a processor in the component identification apparatus, such as a Central Processing Unit (CPU), a Digital Signal Processor (DSP), a Microcontroller Module (MCU) or a Field-Programmable Gate Array (FPGA), or the like.

It should be noted that: when the component identification apparatus provided in the above embodiments performs component identification, illustrations are made only based on the division of the various program modules as above. In actual applications, the above processing can be allocated to different program modules as needed. That is, the internal structure of the apparatus is divided into different program modules so as to complete all or part of the processing described above. In addition, the component identification apparatus embodiment and the component identification method embodiment as provided in the above embodiments belong to the same concept. For the specific implementation process of the component identification apparatus, see the method embodiments (details are omitted).

Based on the hardware implementation of the above program modules, in order to implement the component identification method in the embodiments of the present disclosure, the embodiments of the present disclosure also provide an electronic device. FIG. 10 is a schematic diagram of the structure of the hardware components of an electronic device provided by an embodiment of the present disclosure. As shown in FIG. 10, the electronic device comprises:
a communication interface 1 which can perform information interaction with other devices such as a network device;
a processor 2 which is connected to the communication interface 1 to realize information interaction with other devices and which is used to execute, when running a computer program, the method provided by one or more of the above technical solutions, wherein the computer program is stored in a memory 3.

Of course, in actual applications, the various components in the electronic device are coupled together through a bus system 4. It can be understood that the bus system 4 is used to realize connective communication between these components. In addition to a data bus, the bus system 4 also includes a power bus, a control bus and a status signal bus. However, for the sake of clarity, the various buses are labeled as a bus system 4 in FIG. 10.

The memory 3 in the embodiments of this invention is used to store various types of data so as to support the operations of the electronic device. Examples of such data include any computer program for operating on the electronic device.

It can be understood that the memory 3 may be a volatile memory or a non-volatile memory, or may include both a volatile memory and a non-volatile memory. Among them, the non-volatile memory may be a Read Only Memory (ROM), a Programmable Read-Only Memory (PROM), an Erasable Programmable Read-Only Memory (EPROM), an Electrically Erasable Programmable Read-Only Memory (EEPROM), a Ferromagnetic Random Access Memory (FRAM), a Flash Memory, a magnetic surface memory, an optical disk, or a Compact Disc Read-Only Memory (CD-ROM), wherein the magnetic surface memory may be a magnetic disk memory or a magnetic tape memory: the volatile memory may be a Random Access Memory (RAM), which is used as an external cache. By way of exemplary, but not restrictive illustrations, many forms of RAMs are available, such as a Static Random Access Memory (SRAM), a Synchronous Static Random Access Memory (SSRAM), a Dynamic Random Access Memory (DRAM), a Synchronous Dynamic Random Access Memory (SDRAM), a Double Data Rate Synchronous Dynamic Random Access Memory (DDRSDRAM), an Enhanced Synchronous Dynamic Random Access Memory (ESDRAM), a SyncLink Dynamic Random Access Memory (SLDRAM), and a Direct Rambus Random Access Memory (DRRAM). The memory 2 described in the embodiment of this invention is intended to include, but is not limited to, these and any other suitable types of memories.

The method disclosed in the above embodiments of this invention can be applied to the processor 2 or implemented by the processor 2. The processor 2 may be an integrated circuit chip with signal processing capabilities. In an implementation process, the respective steps of the above method can be completed by an integrated logic circuit of hardware in the processor 2 or instructions in the form of software. The above processor 2 may be a general-purpose processor, a DSP, or other programmable logic devices, discrete gate or transistor logic devices, discrete hardware components, etc. The processor 2 can implement or execute the respective methods, steps and logical block diagrams disclosed in the embodiments of this invention. A general-purpose processor may be a microprocessor, any conventional processor or the like. The steps of the method disclosed in conjunction with the embodiments of this invention can be directly implemented by a hardware decoding processor, or executed by a combination of hardware and software modules in the decoding processor. A software module may be located in a storage medium, which is located in the memory 3, and the processor 2 reads a program in the memory 3 to complete the steps of the aforementioned method in conjunction with its hardware.

When the processor 2 executes the program, the corresponding processes in each method of the embodiments of this invention are implemented. For the sake of simplicity, details are omitted herein.

In an exemplary embodiment, the embodiment of this invention also provides a storage medium, i.e., a computer storage medium, specifically a computer-readable storage medium, such as a memory 3 that stores a computer program, and the above computer program can be executed by the processor 2 so as to complete the steps of the aforementioned method. The computer-readable storage medium may be a memory such as a FRAM, a ROM, a PROM, an EPROM, an EEPROM, a Flash Memory, a magnetic surface memory, an optical disk, a CD-ROM or the like.

In the several embodiments provided in the present disclosure, it should be understood that the apparatus, electronic device and method as disclosed can be implemented in other manners. The device embodiments described above are only illustrative. For example, the division of the units is only a logical function division. In actual implementations, there may be other division manners, for example, multiple units or components may be combined or may be integrated into another system, or some features may be ignored or not executed. In addition, the coupling, direct coupling or communicative connection between the respective components as shown or discussed may be realized through some interfaces, and the indirect coupling or communicative connection of the devices or units may be electrical, mechanical, or others.

The units described above as separate components may or may not be physically separate. The components displayed as units may or may not be physical units, i.e., they may be located in one place or distributed to multiple network units. Some or all of the units can be selected according to actual requirements to achieve the purpose of the solutions of the embodiments.

In addition, all of the functional units in the respective embodiments of the the present disclosure may be integrated into one processing unit, or the respective units may each be used as a unit, or two or more units may be integrated into one unit. The above integrated unit can be implemented in a form of hardware or in a form of hardware plus software functional units.

Those skilled in the art can understand that all or part of the steps to implement the above method embodiments can be completed by hardware related to program instructions. The aforementioned program can be stored in a computer readable storage medium, and the program, when executed, performs the steps of the above method embodiments. However, the aforementioned storage medium includes various media that can store program codes, such as a mobile storage device, a ROM, a RAM, a magnetic disk, an optical disk or the like.

Alternatively, if the above integrated unit in the present disclosure is implemented in a form of a software functional module and is sold or used as an independent product, it can be also stored in a computer readable storage medium. Based on such understanding, the technical solutions of the embodiments of the present disclosure in essence or the parts that contribute to the existing technology can be embodied in the form of a software product. The computer software product is stored in a storage medium and includes several instructions to cause a computer device (which may be a personal computer, a server, a network device, etc.) to execute all or part of the methods described in the respective embodiments of the present disclosure. However, the aforementioned storage medium includes various media that can store program codes, such s a mobile storage device, a ROM, a RAM, a magnetic disk, an optical disk or the like.

It should be noted that the technical solutions disclosed in the embodiments of the present disclosure can be combined arbitrarily as long as there is no conflict. Unless otherwise specified and limited, the term “connection” should be understood in a broad sense. For example, it may be an electrical connection, or may be an internal connection between two components, may be a direct connection, and may also be an indirect connection through an intermediate medium. For those skilled in the art, the specific meanings of the above terms can be interpreted according to specific circumstances.

In addition, in the examples of the present disclosure, “first”, “second” and the like are used to distinguish similar objects and are not necessarily used to describe a particular order or sequence. It should be understood that objects distinguished by “first\second\third” are interchangeable in appropriate circumstances such that the embodiments of the present disclosure may be implemented in an order other than those illustrated or described therein.

The term “and/or” herein is just an association relationship that describes associated objects, indicating that three relationships may exist. For example, A and/or B can indicate three circumstances: A exists alone, A and B exist simultaneously, and B exists alone. In addition, the term “at least one” herein means any one of more or any combination of at least two of more. For example, inclusion of at least one of A, B and C and can mean inclusion of any one or more elements selected from a set consisting of A, B and C.

The above are only specific embodiments of the present disclosure, but the protection scope of the present disclosure is not limited thereto. Any changes or substitutions that can be easily conceived, within the technical ranges disclosed in the present disclosure, by those skilled in the art who are familiar with this technical field should be covered within the protection scope of the present disclosure. Therefore, the protection scope of the present disclosure should be determined by the protection scope of the claims.

The specific technical features in the respective embodiments described in the detailed description of the embodiments can be combined in various ways if there is no conflict. For example, different implementations can be formed through combinations of different specific technical features. In order to avoid unnecessary repetitions, various possible combinations of the respective specific technical features in the present disclosure will not be further described.

1.-12. (canceled)

13. A component identification method, comprising:
inputting a first image into a set identification model to obtain at least one user interface (UI) block in the first image outputted by the set identification model, wherein the first image is determined on the basis of a first visual mockup, the set identification model is used for identifying the at least one UI block in an inputted image, and each UI block at least comprises an image region obtained by UI component rendering;
determining, among nodes of a document object model (DOM) corresponding to the first visual mockup, a first node corresponding to each UI block in the at least one UI block; and
inputting an image corresponding to each first node into a set classification model to obtain a UI component type corresponding to the first node outputted by the set classification model, the set classification model is used for determining a UI component type corresponding to an inputted image.

14. The method according to claim 13, wherein determining, among the nodes of the DOM corresponding to the first visual mockup, a first node corresponding to each UI block in the at least one UI block includes:
traversing the nodes of the document object model (DOM) corresponding to the first visual mockup; and
when a region overlap rate is greater than a first set threshold, determining a node corresponding to the region overlap rate as a first node corresponding to a first UI block, wherein
the region overlap rate represents the overlap rate between a second image and the first UI block, and the second image is obtained by cropping the first visual mockup according to node information of the node.

15. The method according to claim 13, wherein prior to inputting the first image into the set identification model, the method further comprises:
determining, through edge detection, at least two first rectangular regions in the first visual mockup; and
cropping the first visual mockup based on at least one first rectangular region to obtain the first image.

16. The method according to claim 15, wherein cropping the first visual mockup based on at least one first rectangular region includes:
merging the first rectangular regions which are adjacent in a set direction to obtain a second rectangular region, wherein the length of the second rectangular region in the set direction is smaller than a second set threshold; and
cropping the first visual mockup based on the second rectangular region.

17. The method according to claim 13, wherein inputting the image corresponding to each first node into the set classification model includes at least one of:
inputting a second image which is obtained by cropping the first visual mockup according to node information of the first node into the set classification model; and
inputting a third image which is obtained by cropping the first visual mockup according to the UI block corresponding to the first node into the set classification model.

18. The method according to claim 13, wherein prior to inputting the first image into a set identification model, the method further comprises:
training the set identification model and the set classification model based on a second visual mockup which is accordingly provided with at least one first annotation, wherein
the first annotation includes first position information of an image region that can be obtained by rendering with UI components and a corresponding first label, the first position information is used for describing the position of the image region in the second visual mockup, and the first label is used for describing the type of the UI components.

19. The method according to claim 18, wherein training the set identification model and the set classification model based on the second visual mockup which is accordingly provided with the at least one first annotation includes:
cropping the second visual mockup based on each first annotation to obtain corresponding fourth images, wherein the fourth images are accordingly provided with a first label;
replacing the first label of the second visual mockup with second labels to obtain fifth images, wherein the second labels represent that the corresponding image regions are UI blocks;
training the set classification model based on the fourth images; and
training the set identification model based on the fifth images.

20. The method according to claim 19, wherein prior to training the set classification model based on the fourth images, the method further comprises:
when the number of the fourth images corresponding to at least one first label is smaller than a third set threshold, generating a page image containing a corresponding UI component type, and obtaining a corresponding fourth image based on the generated page image.

21. The method according to claim 20, wherein generating the page image containing the corresponding UI component type includes at least one of:
rendering component codes of the corresponding UI component type on a set interface to obtain a page image containing a corresponding UI component type; and
obtaining a third visual mockup with a visual mockup generation code tool to obtain a page image containing the corresponding UI component type.

22. An electronic device, comprising:
a processor; and
a memory for storing a computer program that can run on the processor, wherein
when running the computer program, the processor is used to execute steps of a component identification method, the steps comprising:
inputting a first image into a set identification model to obtain at least one user interface (UI) block in the first image outputted by the set identification model, wherein the first image is determined on the basis of a first visual mockup, the set identification model is used for identifying the at least one UI block in an inputted image, and each UI block at least comprises an image region obtained by UI component rendering;
determining, among nodes of a document object model (DOM) corresponding to the first visual mockup, a first node corresponding to each UI block in the at least one UI block; and
inputting an image corresponding to each first node into a set classification model to obtain a UI component type corresponding to the first node outputted by the set classification model, the set classification model is used for determining a UI component type corresponding to an inputted image.

23. The electronic device according to claim 22, wherein determining, among the nodes of the DOM corresponding to the first visual mockup, the first node corresponding to each UI block in the at least one UI block includes:
traversing the nodes of the DOM corresponding to the first visual mockup; and
when a region overlap rate is greater than a first set threshold, determining a node corresponding to the region overlap rate as a first node corresponding to a first UI block, wherein
the region overlap rate represents the overlap rate between a second image and the first UI block, and the second image is obtained by cropping the first visual mockup according to node information of the node.

24. The electronic device according to claim 22, wherein prior to inputting the first image into the set identification model, the method further comprises:
determining, through edge detection, at least two first rectangular regions in the first visual mockup; and
cropping the first visual mockup based on at least one first rectangular region to obtain the first image.

25. The electronic device according to claim 24, wherein cropping the first visual mockup based on at least one first rectangular region includes:
merging the first rectangular regions which are adjacent in a set direction to obtain a second rectangular region, wherein the length of the second rectangular region in the set direction is smaller than a second set threshold; and
cropping the first visual mockup based on the second rectangular region.

26. The electronic device according to claim 22, wherein inputting the image corresponding to each first node into the set classification model includes at least one of:
inputting a second image which is obtained by cropping the first visual mockup according to the node information of the first node into the set classification model; and
inputting a third image which is obtained by cropping the first visual mockup according to the UI block corresponding to the first node into the set classification model.

27. The electronic device according to claim 22, wherein prior to inputting the first image into the set identification model, the method further comprises:
training the set identification model and the set classification model based on a second visual mockup which is accordingly provided with at least one first annotation, wherein
the first annotation includes first position information of an image region that can be obtained by rendering with UI components and a corresponding first label, the first position information is used for describing the position of the image region in the second visual mockup, and the first label is used for describing the type of the UI components.

28. The electronic device according to claim 27, wherein training the set identification model and the set classification model based on the second visual mockup which is accordingly provided with the at least one first annotation includes:
cropping the second visual mockup based on each first annotation to obtain corresponding fourth images, wherein the fourth images are accordingly provided with a first label;
replacing the first label of the second visual mockup with second labels to obtain fifth images, wherein the second labels represent that the corresponding image regions are UI blocks;
training the set classification model based on the fourth images; and
training the set identification model based on the fifth images.

29. The electronic device according to claim 28, wherein prior to training the set classification model based on the fourth images, the method further comprises:
when the number of the fourth images corresponding to at least one first label is smaller than a third set threshold, generating a page image containing a corresponding UI component type, and obtaining a corresponding fourth image based on the generated page image.

30. The electronic device according to claim 29, wherein generating the page image containing the corresponding UI component type includes at least one of:
rendering component codes of the corresponding UI component type on a set interface to obtain a page image containing a corresponding UI component type; and
obtaining a third visual mockup with a visual mockup generation code tool to obtain a page image containing the corresponding UI component type.

31. A storage medium storing thereon a computer program which performs steps of the method according to claim 13 when executed by the processor.
